(19) United States
(12) Patent Application Publication
(10) Pub. No.: US 2007/0110093 A1
(43) Pub. Date: May 17, 2007

(54) CHANNEL SCANNING DEVICE AND METHOD THEREOF

(75) Inventor: CHENG-WEN TANG, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,124

(22) Filed: Jun. 24, 2006

(30) Foreign Application Priority Data
Nov. 11, 2005 (CN) 200510101195.X

(51) Int. Cl. H04L 12/42

(52) U.S. Cl. 370/450

(57) ABSTRACT

A channel scanning device (100) for scanning channel status of a wireless local area network (WLAN) is provided. The channel scanning device includes a status recording module (120), a transmission module (130), and a probing module (140). The status recording module is used for setting up a channel status list including multiple sequence fields and status fields, the sequence fields representing a channel sequence, and one sequence field together with a status field corresponding to each channel. The probing module is used for pre-probing the channel according to the channel sequence, in order to find an idle channel, probing the idle channel, and recording the channel status into the channel status list set up by the status recording module. The transmission module is used for transmitting a pre-probe packet over the idle channel. A channel scanning method for scanning channel status of the WLAN is also disclosed.

### FIELD OF THE INVENTION

The present invention relates to wireless communication, and particularly to wireless local area network (WLAN) communication.

### DESCRIPTION OF RELATED ART

In a WLAN communication system, before a station transmits data, the station is required to set up an association with an access point. For associating with the access point, the station must scan WLAN channels to determine whether there are idle channels that can be employed.

Passive-scanning is one type of channel scanning mode in a WLAN communication system. Under the passive-scanning mode the access point transmits a beacon via a channel at fixed time intervals, and the station waits for the beacon. The time interval is typically in a range of 100 ms˜1000 ms (specified by Wireless Fidelity Association). Therefore, the station spends at least 1100 ms scanning 11 channels (defined by the American IEEE 802.11b) in performing the passive-scan. There is room for improvement on the time spent on the passive-scan.

Therefore, a heretofore unaddressed need exists in the industry to overcome the aforementioned deficiencies and inadequacies.

### SUMMARY OF THE INVENTION

A channel scanning device for scanning channel status of a wireless local area network (WLAN) is provided. The channel scanning device includes a status recording module, a transmission module, and a probing module. The status recording module is used for setting up a channel status list including multiple sequence fields and status fields, the sequence fields representing a channel sequence, and one sequence field together with a status field corresponding to each channel. The probing module is used for pre-probing the channels in sequence according to the channel sequence fields, in order to find an idle channel, probing the idle channel, and recording the channel status into the channel status list set up by the status recording module. The transmission module is used for transmitting a pre-probe packet over the idle channel.

A channel scanning method for scanning the channel status of the WLAN is also provided. The channel scanning method includes: setting up a channel status list including multiple sequence fields and status fields, the sequence fields representing a channel sequence, and one sequence field and one status field corresponding to each channel; pre-probing the channels in sequence according to the channel sequence fields, in order to find an idle channel, and transmitting the pre-probe packet over the idle channel for preventing another station from transmitting any packet over the idle channel; and probing only the idle channels in sequence according to the channel sequence fields.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a block diagram of a channel scanning device in accordance with an exemplary embodiment of the invention;

FIG. 2 is a timing diagram of scanning five channels by the channel scanning device of FIG. 1;

FIG. 3 is a framework of a CTS packet;

FIG. 4 is a flowchart of channel scanning by the channel scanning device of FIG. 1, including steps of pre-probing and probing;

FIG. 5 is a detailed flowchart of the steps of pre-probing of FIG. 4; and

FIG. 6 is a detailed flowchart of the steps of probing of FIG. 4.

### DETAILED DESCRIPTION OF THE INVENTION

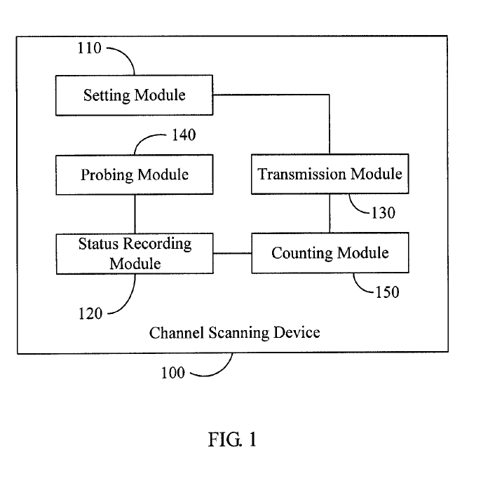

FIG. 1 is a block diagram of a channel scanning device 100 in accordance with an exemplary embodiment of the invention. In this embodiment, the channel scanning device 100 is used for scanning channels and determining their status. The channel scanning device 100 is applicable to various wireless local area network (WLAN) devices, such as access points or personal computers with WLAN cards.

The channel scanning device 100 comprises a setting module 110, a status recording module 120, a transmission module 130, a probing module 140, and a plurality of counting modules 150. It should be noted that for the purpose of simplicity, only one counting module 150 is illustrated.

The status recording module 120 is used for setting up a channel status list, and recording the channel status into the channel list. The channel status list is used for storing a status of each channel. The channel status list includes multiple sequence fields and status fields. The sequence fields represent a channel sequence. There are one sequence field and one status field for each corresponding channel. The status of a channel may be busy or idle. If a packet is being transmitted over a channel at a time of scanning, the channel is busy. If no packet is being transmitted over the channel at the time of scanning, the channel is idle. The status recording module 120 is further used for surveying the channel status of the WLAN by querying the status fields of the channel status list.

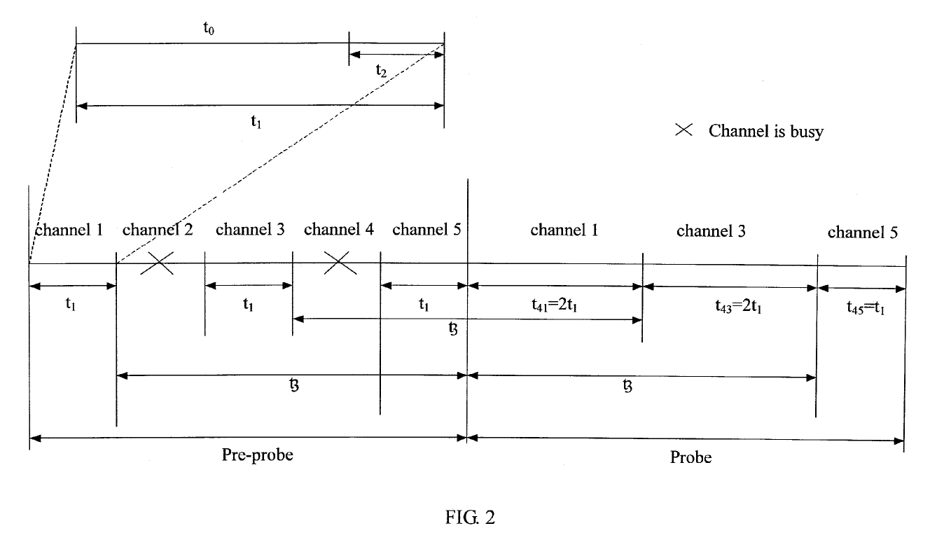

The setting module 110 is used for setting a pre-probe time (t₁) and a waiting time (t₃). FIG. 2 is a timing diagram of scanning five channels by the channel scanning device 100. The pre-probe time (t₁) is a minimum time length of scanning the channel by the channel scanning device 100, and includes an inspection time (t₀) and a transmission time (t₂). The inspection time (t₀) is defined as 200 μs. The transmission time (t₂) is a time length of transmitting a pre-probe packet. The waiting time (t₃) is a time interval between the end of pre-probing one channel and the beginning of probing that channel, which is equal to [the pre-probe time (t₁)*(the number of channels-1)], and is pre-set in a duration field of the pre-probe packet by the setting module 110. In this embodiment, the waiting time (t₃) is equal to t₁*(5−1), namely 4‘t₁.

The counting module 150 is used for counting down the inspection time (t₀), the pre-probe time (t₁), the transmission time (t₂), and the waiting time (t₃). The counting module 150 first counts according to the inspection time (t₀).

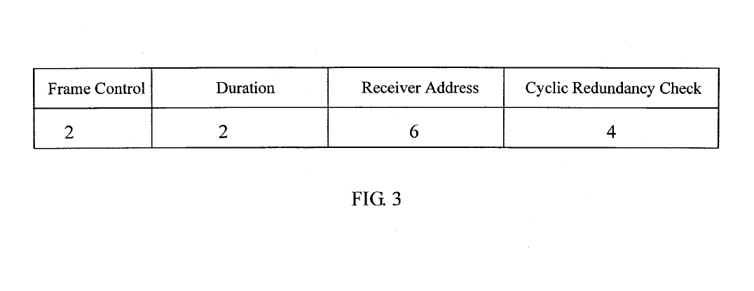

In this embodiment, the pre-probe packet is a clear-to-send (CTS) packet. FIG. 3 is a framework of the CTS packet. The CTS packet is one type of MAC service data unit (MSDU), and includes a ‘frame control’ field, a ‘duration’ field, a ‘receiver address’ field, and a ‘cyclic redundancy check’ field. In this embodiment, the CTS packet is 14 bytes. The receiver address field denotes an address of the channel scanning device 100 being 6 bytes.

In this embodiment, the transmission time (t₂) is a time length of transmitting the CTS packet. According to the IEEE 802.11b standard, the transmission time (t₂) is expressed as: t₂=T_{DIFS}+T_{PLCP}+T_{MSDU}, wherein T_{DIFS}=50 μs, T_{PLCP}=192 μs, T_{MSDU}=(14×8) bits/(2×106 bits/1×106 μs)=56 μs, thus, t₂=T_{DIFS}+T_{PLCP}+T_{MSDU}=50 μs+192 μs+56 μs=298 μs, and t₁=t₀+t₂=t₀+298 μs. T_{DIFS} represents time of a distribution inter frame space. T_{PLCP} is a time length of transmitting a long preamble via the physical layer convergence protocol (PLCP). T_{MSDU} is a time length of transmitting the CTS packet at a rate of 2 Mbps. Therefore t₁ is equal to 498 μs.

In this embodiment, since 11 channels are specified in the American IEEE 802.11b standard, the transmission module 130 needs to transmit the CTS packet up to 11 times.

The transmission module 130 is used for transmitting the pre-probe packet over the channel, and determining whether the pre-probe packet is transmitted within the pre-probe time (t₁). The duration field of the pre-probe packet contains the waiting times (t₃).

The probing module 140 is used for pre-probing the channels in sequence according to the channel sequence fields, in order to find an idle channel, and for probing the idle channel.

In this embodiment, the probing module 140 first pre-probes the channels in sequence according to the channel sequence fields. During the process of pre-probing, if a packet is being transmitted over a channel, the channel is identified as busy, and the status recording module 120 records a busy for that channel on the channel status list; if no packet is being transmitted over a channel, the channel is identified as idle, and the status recording module 120 records that channel as being idle on the channel status list and a pre-probe packet is transmitted over that channel. After the pre-probe process is finished, the probing module 140 probes the idle channels only, skipping the busy channels.

In this embodiment, the probing module 140 must return to the idle channel within the waiting time (t₃) for probing the idle channel again. The waiting time (t₃) typically contains a buffer time, such as 5 μs, for switching from one channel to another. As shown in FIG. 2, channels 2 and 4 are identified as busy; channels 1, 3, and 5 are identified as idle. After the counting module 150 counts the waiting time of channel 1, the probing module 140 returns to channel 1 for probing. Because channel 2 and channel 4 are busy, the probing module 140 skips channel 2 and channel 4, and only probes channel 1, 3, and 5. The probe times of channels 1 and 3 is double that of what the pre-probe time was for channels 1, 3, so that that overall probe time for the three idle channels is equal to that of the overall pre-probe time of all five channels.

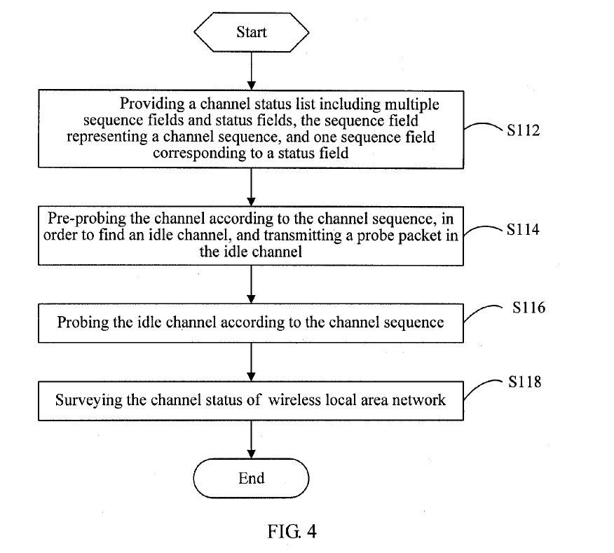

FIG. 4 is a flowchart of scanning the channel by the scanning device 100 of FIG. 1. In this embodiment, the number of channels specified by American IEEE 802.11b standard is 11.

In step S112, the status recording module 120 sets up the channel status list. The channel status list includes multiple sequence fields and status fields. The sequence fields represent a channel sequence, and there is one sequence field and one status field corresponding to each channel.

In this embodiment, for example, the channel 1 corresponds to the first sequence field of the channel status list, the channel 2 corresponds to the second sequence field of the channel status list, and so on.

In step S114, the probing module 140 pre-probes the channels in sequence according to the channel sequence fields, in order to find an idle channel, and transmits the pre-probe packet over the idle channel.

In this embodiment, the setting module 110 first sets the pre-probe time of all the channels. Then the probing module 140 pre-probes the channels in sequence according to the channel sequence fields. For example, the probing module 140 first pre-probes channel 1. If channel 1 is busy, the status recording module 120 records a busy status into the first status field of the channel status list. Then the probing module pre-probes channel 2. If channel 1 is idle, the status recording module 120 records an idle status into the first status field of the channel status list; and then the transmission module 130 transmits the pre-probe packet over channel 1. Then the probing module 140 switches to channel 2, and so on.

In step S116, the probing module 140 probes the idle channels in sequence. In this embodiment, the setting module 110 first sets a probe time of the idle channels. Then the probing module 140 continues probing each of the idle channels in sequence for the designated probe time. During the process of probing, if any channel is busy, the status recording module 120 records the busy status into a corresponding status field of the channel status list; if any channel is idle, the status recording module 120 records the idle status into the corresponding status field of the channel status list.

In step S118, the status recording module 120 surveys the channel status of the WLAN. In this embodiment, the status recording module 120 surveys the channel status of the WLAN by querying the status field of the channel status list.

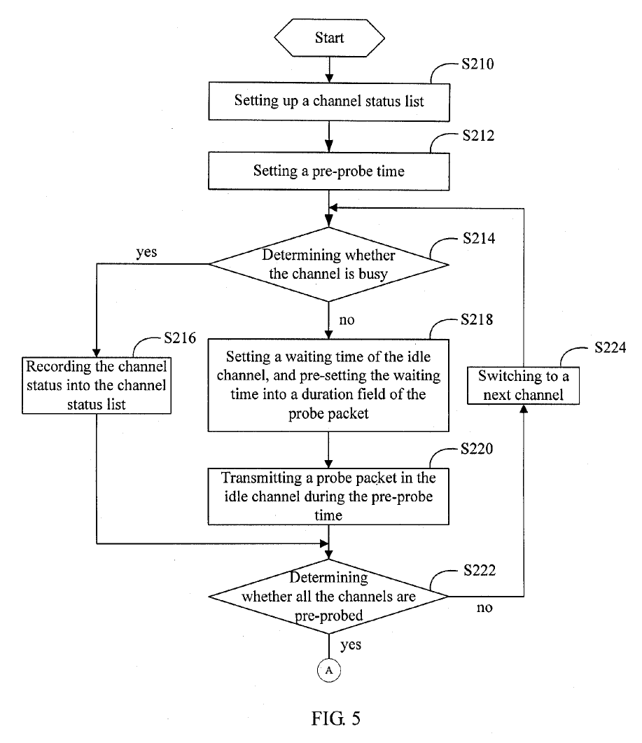

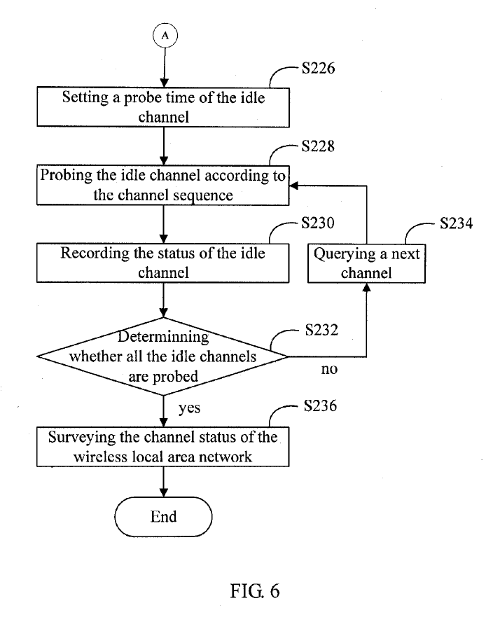

FIG. 5 and FIG. 6 are detailed flowcharts of steps of pre-probing and probing the channels as outlined in FIG. 4. In step S210, the status recording module 120 sets up the channel status list. In step S212, the setting module 110 sets the pre-probe time. In this embodiment, the pre-probe time includes the inspection time and the transmission time.

In step S214, the probing module 140 checks each channel in sequence to determine if it is busy according to the channel sequence fields. If a packet is being transmitted over the channel, the channel is busy; if no packet is being transmitted over the channel, the channel is idle. In this embodiment, the probing module 140 first probes the channel 1. If a packet is being transmitted over the channel 1, the channel 1 is busy; if no packet is being transmitted over the channel 1, the channel 1 is idle. Then the probing module 140 switches to channel 2, and so on.

If the channel is busy, the process proceeds to step S216, where the probing module 140 records the channel status into the channel status list. In this embodiment, the probing module 140 records the busy status into the corresponding status field of the channel status list. If the channel is idle, the process proceeds to step S218.

In step S218, the setting module 110 sets the waiting time of the idle channel, and pre-sets the waiting time into the duration field of the pre-probe packet. In this embodiment, the waiting time is equal to [10*the pre-probe time].

In step S220, the transmission module 130 transmits the pre-probe packet over the idle channel during the pre-probe time.

In step S222, the probing module 140 determines whether all the channels have been pre-probed. In this embodiment, if not all the channels have been pre-probed, the process proceeds to step S224 to switch to the next channel, and then step S214 to S224 are repeated, until all the channels are pre-probed. If all the channels have pre-probed, the process proceeds to step S226.

Referring to FIG. 6, in step S226, the setting module 110 sets the probe time of the idle channel. In this embodiment, if all the channels are idle, the probe time of each channel is equal to the pre-probe time. If a channel is busy, the probe time of an idle channel previous to the busy channel is double the pre-probe time.

In step S228, the probing module 140 probes the idle channels in sequence according to the channel sequence list. In this embodiment, the probing module 140 first keeps probing the idle channel with a minimum number in the sequence field of the channel status list for the probe time. During the process of probing, the counting module 150 counts down the probe time of the idle channel. In other embodiments the counting module may count up to track the probe time.

In step S230, the status recording module 120 records the channel status of the idle channel. In this embodiment, the status recording module 120 records the channel status of the idle channel after finishing counting down the probe time.

In step S232, the probing module 140 determines whether all the idle channels have been probed. In this embodiment, the probing module 140 determines whether all the idle channels have been probed by querying the status list. If all the idle channels have been probed, the process proceeds to step S236, where the status recording module 120 surveys the channel status of the WLAN. If all the idle channels have not been probed, the process proceeds to step S234 to query the next channel, and then step S226 to S232 are repeated, until all the idle channels have been probed.

In this embodiment, if eleven idle channels are probed during the pre-probe process, the scanning time is equal to 10.956 ms (2×amount of channels×t₁). And so it is apparent, the scanning time in this embodiment is less than the passive scan 55 ms.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A channel scanning device for scanning channel status of a wireless local area network (WLAN), comprising:
a status recording module for setting up a channel status list comprising multiple sequence fields and status fields, the sequence fields representing a channel sequence, and one sequence field corresponding to a status field, and recording the channel status into the channel list;
a probing module for pre-probing the channel in sequence according to the channel sequence fields, in order to find an idle channel, probing the idle channel; and
a transmission module for transmitting a pre-probe packet over the idle channel.

2. The channel scanning device as recited in claim 1, further comprising a setting module for setting a pre-probe time, and a waiting time.

3. The channel scanning device as recited in claim 2, wherein the pre-probe time comprises an inspection time and a transmission time.

4. The channel scanning device as recited in claim 3, further comprising multiple counting modules for counting down the inspection time, the pre-probe time, the waiting time, and the transmission time.

5. The channel scanning device as recited in claim 3, wherein the waiting time is equal to [the pre-probe time*(the number of channels−1)], and is pre-set in a duration field of the pre-probe packet by the setting module.

6. The channel scanning device as recited in claim 3, wherein the transmission module is also for determining whether the pre-probe packet is transmitted within the pre-probe time.

7. The channel scanning device as recited in claim 1, wherein the pre-probe packet is a clear-to-send (CTS) packet.

8. A channel scanning method for scanning channel status of a wireless local area network (WLAN), comprising:
providing a channel status list comprising multiple sequence fields and status fields, the sequence fields representing a channel sequence, and one sequence field corresponding to a status field;
pre-probing the channels in sequence according to the channel sequence fields, in order to find an idle channel, and transmitting a pre-probe packet over the idle channel; and
probing the idle channels in sequence according to the channel sequence fields.

9. The channel scanning method as recited in claim 8, further comprising a step of determining in sequence, whether each channel is busy according to the channel sequence fields.

10. The channel scanning method as recited in claim 9, wherein if a packet is being transmitted over a channel, that channel is busy; if no packet is being transmitted over the channel, that channel is idle.

11. The channel scanning method as recited in claim 10, further comprising a step of recording the channel status into the corresponding field of the channel status list, if the channel is busy.

12. The channel scanning method as recited in claim 10, further comprising a step of setting a waiting time of the idle channel, and pre-setting the waiting time in a duration field of the pre-probe packet, if the channel is idle.

13. The channel scanning method as recited in claim 12, further comprising a step of transmitting the pre-probe packet over the idle channel during the pre-probe time.

14. The channel scanning method as recited in claim 13, further comprising a step of determining whether all the channels are pre-probed.

15. The channel scanning method as recited in claim 14, further comprising a step of setting the probe time of the idle channel if all the channels are pre-probed.

16. The channel scanning method as recited in claim 15, further comprising a step of probing the idle channels in sequence according to the channel sequence fields, and counting down the probe times of the idle channels.

17. The channel scanning method as recited in claim 8, further comprising a step of surveying the channel status of the WLAN by querying the status field of the channel status list.

18. A method for scanning status of channels in a wireless local area network (WLAN), comprising:
pre-probing preset communicable channels in a WLAN in sequence by means of transmitting a predetermined packet, including a waiting time therein which is set based on a total number of said channels, on each of said channels; and
probing said each of said channels to determine status thereof according to reply to said transmitted pocket of said each of said channels after said pre-probing step for said each of said channels is completed and said waiting time expires.

19. The method as recited in claim 18, further comprising the step of identifying original status of said channels to exclude busy channels from said channels before said pre-probing step.

20. The method as recited in claim 18, wherein said waiting time in said predetermined pocket is equal to a product of a completing time of said pre-probing step for said each of said channels and said total number of said channel minus 1.
